(19) United States
(12) Patent Application Publication
(10) Pub. No.: US 2004/0078428 A1
(43) Pub. Date: Apr. 22, 2004

(54) Legacy system interface

(76) Inventor: Paul J Cherry, Ipswich Suffolk (GB)

Correspondence Address: Nixon & Vanderhye, 8th Floor, 1100 North Glebe Road, Arlington, VA, 22201-4714, US

(21) Appl. No.: 10/471,425

(22) PCT Filed: Mar. 27, 2002
(86) PCT No.: PCT/GB02/01406

(30) Foreign Application Priority Data
Mar. 29, 2001 (EP) 01302945.9

(51) Int. Cl. G06F 15/16

(52) U.S. Cl. 709/203; 709/227

(57) ABSTRACT

A system for interfacing to a legacy computer system comprises a plurality of transaction servers for communicating with the host system and a control hub for controlling communications between a plurality of clients and the plurality of servers. A database connected to the control hub provides a flexible communications interface. Each of the plurality of servers has an associated database holding data which is used to drive the servers to extract information from the legacy system under the control of the control hub.

This invention relates to the field of legacy systems, particularly but not exclusively to the transfer of information to and/or from legacy or host systems.

During the early stages of computer development, computers were cumbersome and difficult to work with, with user interaction often being limited to user-unfriendly text-based screen displays. Stored information was accessed through dumb terminals, often requiring specific commands, keystroke sequences and key based cursor movement to retrieve information. Nevertheless, in many organisations, such computers were and are used to store a vast amount of data, since the migration of the data onto more modern systems can be both difficult and costly to implement. To enable data input to and/or information retrieval from such legacy systems, also referred to herein as host systems, techniques known as screen scraping are used. Screen scraping involves the creation of a virtual session on the host machine using, for example, a modern desktop computer to emulate a dumb terminal, and writing dedicated code to replicate the sequence of instructions that is necessary to retrieve specific information.

However, screen scraper systems are intrinsically hostile to host systems, since they seek to work around the constraints imposed by the host system. Therefore, errors in the screen scraper program can easily crash the host system. Additionally, screen scraper applications can cause performance problems for a host computer as the speed at which they work and the sheer volume of work they generate far exceed that which would be expected from a human. As a result, the code for establishing each virtual session has to be extensively tested to ensure that it will not create any such problems. Furthermore, the aim of creating a virtual session is to enable the simultaneous running of a number of such sessions, each requesting a variety of information from the host system. Such uncontrolled interaction with the host system can again lead to system failure.

The present invention aims to address the above problems.

According to the present invention, there is provided apparatus for providing an interface between a client application and a host computer system, comprising a plurality of servers for communicating with the host system, a control hub for controlling communications between the client application and the host system and a database connected to the control hub, wherein the control hub is arranged to control said communications in accordance with data held in the database.

By providing a control hub which can control the servers, the sessions to be established by each server can be controlled, so allowing control of the number of sessions which can seek to access particular aspects of the host system and the amount and speed of work undertaken.

According to the invention, there is further provided apparatus for controlling an interface to a host computer system, comprising means for receiving requests for information from a plurality of clients, means for associating each of said requests for information with data stored in a database, said data representing instructions for the host system and means for instructing a server to retrieve information from the host system in accordance with the data.

The invention also provides a transaction server for use in an interface between a client application and a host computer system, the interface including a plurality of servers for communicating with the host system, a control hub for controlling communications between the client application and the host system and a first database connected to the control hub, the control hub being arranged to control said communications in accordance with data held in the first database, the transaction server comprising means for receiving the data from the control hub and a second database connected to the server, further comprising means arranged to interrogate the host system in accordance with the received data and the data stored in the second database.

According to the invention, there is in addition provided a method of interfacing to a host computer system, comprising the steps of requesting information from a control hub, the hub being arranged to control communications between a client and the host system via a plurality of servers, retrieving instructions to be input to the host system from a database connected to a selected server and inputting the instructions to the host system via the selected server.

Embodiments of the invention will now be described, by way of example, with reference to the accompanying drawings, in which:

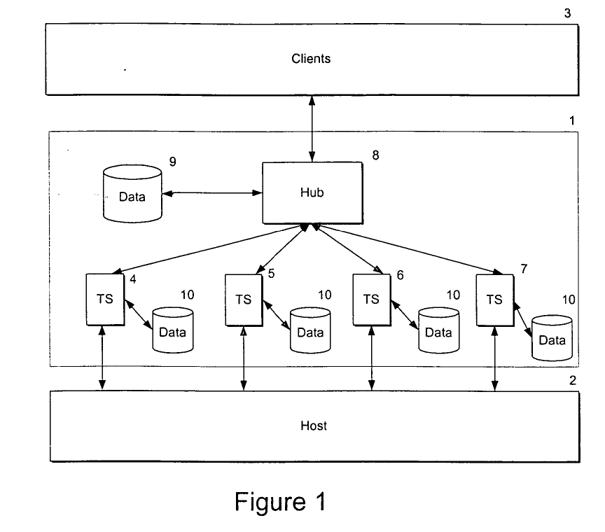

FIG. 1 is a schematic diagram of an information retrieval system according to the invention;

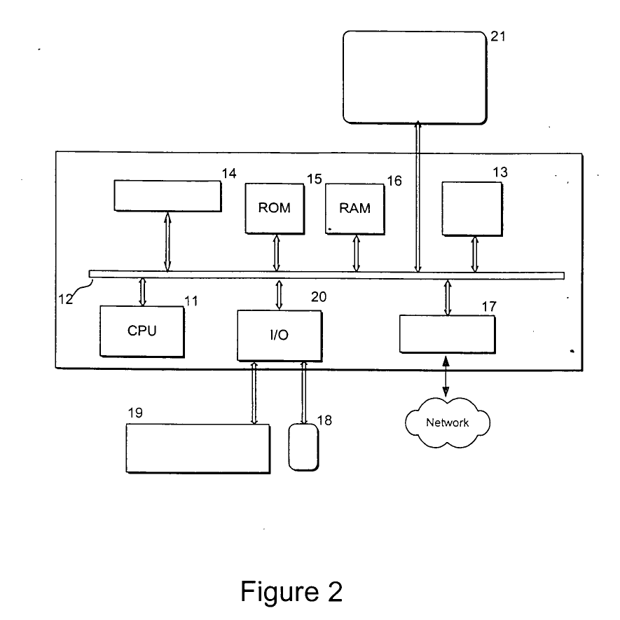

FIG. 2 is a schematic diagram of a conventional server computer; and

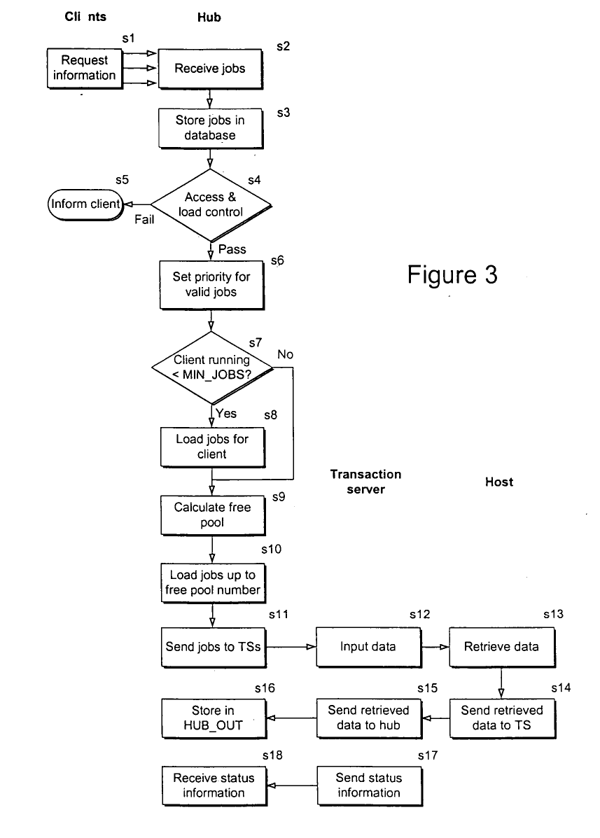

FIG. 3 is a flow diagram illustrating the operation of the information retrieval system of FIG. 1.

FIG. 1 illustrates an information transfer interface 1 between a legacy or host system 2 and a plurality of clients 3 that requires information from the host system 2. The interface 1 comprises a group of server computers 4-7, referred to herein as transaction servers (TS), connected to the host system 2 and controlled via a hub computer 8. The transaction servers 4-7 are essentially data driven interfaces into the host system 2. Although 4 transaction servers are shown, the interface can have fewer or more servers, for example 15 servers. The hub computer 8 is connected to a database 9, for example an Oracle database, which is used as a communication mechanism for the clients 3 to be able to talk through the transaction servers 4-7 to the host system 2, as will be described in detail below. Each of the transaction servers 4-7 is associated with a local copy 10 of a database which defines the host actions to be taken on behalf of the client applications 3.

Each of the transaction servers 4-7 is capable of establishing 30 virtual sessions. On the assumption that there are 15 transaction servers in total, this makes a possible 450 sessions.

A typical architecture for each of the computers 4-8 on which software implementing the invention can be run, is shown in FIG. 2. Each computer comprises a central processing unit (CPU) 11 for executing computer programs and managing and controlling the operation of the computer. The CPU 11 is connected to a number of devices via a bus 12, the devices including a first storage device 13, for example a hard disk drive for storing system and application software, a second storage device 14 such as a floppy disk drive or CD/DVD drive for reading data from and/or writing data to a removable storage medium and memory devices including ROM 15 and RAM 16. The computer further includes a network card 17 for interfacing to a network. The network connection enables, for example, the control hub 8 to connect to each of the transaction servers 4-7, and the transaction servers 4-7 to connect to the host 2. The computer can also include user input/output devices such as a mouse 18 and keyboard 19 connected to the bus 12 via an input/output port 20, as well as a display 21. It will be understood by the skilled person that the above described architecture is not limiting, but is merely an example of a typical computer architecture. It will be further understood that the described computer has all the necessary operating system and application software to enable it to fulfil its purpose.

The organisation of the database 9 will now be explained in detail. The following tables exist in the database:

The TRANS_TYPES table holds a list of transactions and their priority, on a scale of 1-10. Each transaction, identified by a transaction identifier TI, comprises a series of instructions which will form the basis of an interrogation session between a transaction server 4-7 and the host 2. Each transaction is associated with a priority level to enable the hub 8 to prioritise the jobs it receives in accordance with the importance of the job.

The CLIENTS table holds a list of all client applications 3 together with the parameters MIN_JOBS, which represents the number of sessions which are dedicated to those clients and MAX_JOBS, which represents the maximum number of jobs that a client is permitted to run on the hub 8 at one time.

The HUB_IN table holds new jobs, with a parameter PRI_INDEX representing the order in which they are to be processed.

The HUB_OUT table holds all the responses, i.e. the result of job requests placed in HUB_IN. The Hub 8 actively manages this table and deletes any responses that have been read by client applications 3.

A number of registry settings are also relevant:

The Priority Index Modifier is a registry setting that is a multiplier for the priority to allow priority tuning. Its default value is 1.

The parameter Max Sessions is a registry setting specifying the number of mainframe sessions available to the hub

Referring to FIG. 3, a client application 3 requiring information from the host 2 first makes a request for the information from the hub 8 (step s1). The request relates to a transaction which has previously been set up in the local databases 10. A transaction is defined by a series of database tables specifying the screen actions needed to access the host system 2. The screen actions specify each screen of the host system 2 and how information is organised on the screen. The request is in the general form TI/input_message, where TI is the transaction identifier and input_message represents parameters which are used in conjunction with the screen actions, such as the data to be displayed when the transaction is running. A client application 3 calls a transaction and supplies any required arguments. The transaction server 4-7 to which the transaction is allocated looks up the transaction in the Transactions table, which defines the start point for each transaction. The transaction also defines the returned values and their order.

The hub 8 receives such requests, referred to herein as jobs, from a plurality of clients (step s2) and every processing cycle, loads the jobs into the HUB_IN database table (step s3). It then performs certain access and load control checks (step s4). These checks are part of the functionality of the hub 8. One of the functions of the hub is access control, to ensure that only requests from approved IP (Internet Protocol) addresses are accepted. Another function is load limitation, to ensure that the host is not overloaded and to allocate host time between various users fairly. The load limitations are expressed, for example, as maximum requests per hour/day per client and maximum concurrent jobs per client. The client IP addresses are arranged, for example, into projects and all of the relevant parameters set at the project level.

If the client request fails the access or load checks, the client is informed accordingly (step s5). For all client requests that pass the access and load control checks, the hub 8 sets the parameter PRI_INDEX for each job to determine the order in which the jobs will be executed (step s6). PRI_INDEX is set in accordance with the priority for the requested transaction specified in the TRANS_TYPES table, for example, as the system time+(Transaction priority*Priority index modifier) in minutes.

The hub then determines if the client is running fewer jobs than MIN_JOBS (step s7). If this is the case, then the client is not making use of all the sessions dedicated to it and the hub 8 is loaded with the amount of jobs for this client which bring the running jobs up to MIN_JOBS, assuming sufficient jobs exist (step s8). Jobs are loaded in accordance with the PRI_INDEX parameter, starting with the lowest first.

At the next step, or if the client is already running MIN_JOBS, the free session pool is calculated (step s9), as follows:

FREE POOL=Max Sessions−MIN_JOBS for all clients−No. of jobs over MIN_JOBS

For example, if:

Max Sessions=100

Client 1 has MIN_JOBS=10 & a total of 12 jobs running

Client 2 has MIN_JOBS=20 & a total of 5 jobs running

Then FREE POOL=100−(10+20)−2=68

The hub 8 then loads the remaining jobs from the database 9 up to the limit specified by FREE POOL (step s10). The jobs are loaded in the order determined by PRI_INDEX, irrespective of the client. Once the jobs loaded for a client reach the MAX_JOBS limit for the client, no further jobs are loaded for the client.

The hub 8 then sends the jobs to the transaction servers 4-7 which have capacity (step s11). The transaction server 4-7 which receives a job supplies the host with the data for the transaction as extracted from the local database (step s12). The host 2 then carries out the set of screen actions defined by the data (step s13). For example, for a particular transaction identifier TI=4, the associated set of screen actions is, for example:

Search for Value 1

If found

Read from 2 characters right from where Value 1 was found for length

iLength and Store in the field whose name is in Value 2

If not found

If action is optional go to next action

Else Raise error—field not found—and exit

where, for example, Value 1 and iLength are parameters passed in the input_message from the client application and the return string, for example, <Value 2>, is set in the Transactions table.

As a further example, for TI=12, the associated set of screen actions is:

Split Value1 into Operator and OpValue (e.g. −2 becomes − and 2)

If Value2 is not set then default it to 0

If Operator is = then set Value2 equal to OpValue

If Operator is − then take OpValue away from what is in Value2

If Operator is + then add OpValue to what is in Value2

If Operator is * then multiply OpValue with what is in Value2

If Operator is /or \ then divide what is in Value2 by OpValue

If OpValue or Value2 is not numeric then raise error—bad data—and exit transaction.

The requested data is transferred from the host 2 to the transaction server 4-7 (step s14) and the transaction server 4-7 in turn returns the result to the hub 8 (step s15), which stores it in the HUB_OUT table (step s16).

Each of the transaction servers 4-7 periodically sends a status message (step s17) which is received at the hub (step s18) and informs the hub of, for example, the status of the transaction server and how much work it can take, for example, the number of available sessions.

While the hub 8 is described as retrieving information by interrogating the host 2, a cache memory can be provided to cache information at the hub, so that information which has previously been retrieved from the host 2 can be quickly provided in response to a transaction request, thereby reducing the work the host system has to do.

1. Apparatus for providing an interface between a client application and a host computer system, comprising:
a plurality of servers for communicating with the host system;
a control hub for controlling communications between the client application and the host system; and
a database connected to the control hub;
wherein the control hub is arranged to control said communications in accordance with data held in the database.

2. Apparatus according to claim 1, wherein in response to a client request for information from the host system, the control hub is arranged to initiate an information request transaction between a selected one of the plurality of servers and the host system.

3. Apparatus according to claim 2, further comprising a local database associated with the selected server, wherein said transaction comprises a sequence of instructions for retrieving information from the host system, said instructions corresponding to data items stored in the local database.

4. Apparatus according to claim 3, wherein said data items are identified by a transaction identifier.

5. Apparatus for controlling an interface to a host computer system, comprising:
means for receiving requests for information from a plurality of clients;
means for associating each of said requests for information with data stored in a database, said data representing instructions for the host system; and
means for instructing a server to retrieve information from the host system in accordance with the data.

6. Apparatus according to claim 5, wherein the stored data represents a transaction, each transaction being associated with a transaction identifier by which the stored data is associated with an information request.

7. Apparatus according to claim 6, wherein each transaction is associated with a predetermined priority, to determine its order of execution by the control apparatus.

8. Apparatus according to claim 7, wherein the order of execution is dependent on the number of transactions being executed for users to whom dedicated sessions are allocated.

9. A transaction server for use in an interface between a client application and a host computer system, the interface including a plurality of servers for communicating with the host system, a control hub for controlling communications between the client application and the host system and a first database connected to the control hub, the control hub being arranged to control said communications in accordance with data held in the first database, the transaction server comprising:
means for receiving the data from the control hub; and
a second database connected to the server, further comprising means arranged to interrogate the host system in accordance with the received data and the data stored in the second database.

10. A transaction server according to claim 9, wherein the data stored in the second database comprises data defining the instructions for interrogating the host system.

11. A transaction server according to claim 9 or 10, further comprising means for sending the result of the interrogation to the control hub.

12. A transaction server according to claim 9, 10 or 11, the server being configured to send status information to the control hub.

13. A transaction server according to claim 12, wherein the status information includes information relating to the capacity of the server to carry out transactions.

14. A method of interfacing to a host computer system, comprising the steps of:
requesting information from a control hub, the hub being arranged to control communications between a client and the host system via a plurality of servers;
retrieving instructions to be input to the host system from a database connected to a selected server; and
inputting the instructions to the host system via the selected server.

15. A method according to claim 14, further comprising retrieving the information from the host system and transferring it to the hub.
